(19) United States
(12) Patent Application Publication
(10) Pub. No.: US 2026/0064348 A1
(43) Pub. Date: Mar. 5, 2026

(54) Augmented-reality system and method

(71) Applicant: Ford Global Technologies, LLC, Dearborn, MI (US)

(72) Inventors: Mansoor Nasir, Canton, MI (US); RAMI AL KHATIB, Dearborn, MI (US); Mahmoud Yousef Ghannam, Canton, MI (US); John Robert Van Wiemeersch, Novi, MI (US)

(73) Assignee: Ford Global Technologies, LLC, Dearborn, MI (US)

(21) Appl. No.: 18/817,308

(22) Filed: Aug. 28, 2024

(51) Int. Cl. G06F 3/14; G06V 20/59; G06V 40/10

(52) U.S. Cl. CPC G06F 3/1454; G06V 20/59; G06V 40/10

(57) ABSTRACT

A computer includes a processor and a memory, and the memory stores instructions executable by the processor to determine that a user of a display screen is wearing augmented-reality glasses based on image data depicting the user and, in response to determining that the user is wearing the augmented-reality glasses and in response to identifying a portion of content for display by the display screen as including restricted data, display the portion with the augmented-reality glasses and omit the portion from displaying on the display screen. The display screen is separate from the augmented-reality glasses.

### BACKGROUND

Modern vehicles often include audiovisual systems, which can include a display screen and speakers. Display screens can be of various types suitable for displaying content legible to occupants of a vehicle, such as light-emitting diode (LED), organic light-emitting diode (OLED), liquid crystal display (LCD), plasma, digital light processing technology (DLPT), etc. Speakers may be mounted in different locations in a passenger compartment so as to emit sound to the occupants of the vehicle.

### BRIEF DESCRIPTION OF THE DRAWINGS

FIG. 1 is a side diagrammatic view of a portion of an example vehicle including an example augmented-reality system.

FIG. 2 is a diagram of example content being displayed on augmented-reality glasses of the augmented-reality system overlaid on a display screen of the augmented-reality system.

FIG. 3 is a flowchart of an example process for controlling the augmented-reality system.

### DETAILED DESCRIPTION

This disclosure provides techniques for an augmented-reality system to selectively display portions of content through different devices, in order to keep certain data restricted to a specific user. The devices are a display screen and augmented-reality (AR) glasses. The display screen is separate from the AR glasses; for example, the display screen may be part of a personal device of a user or a vehicle that the user is occupying. A computer is programmed to determine that the user of the display screen is wearing the AR glasses based on image data depicting the user. Certain content is set for display by the display screen. The computer is further programmed to, in response to determining that the user is wearing the AR glasses and in response to identifying a portion of the content as including restricted data, display the restricted portion with the AR glasses and prevent the restricted portion from displaying on the display screen. In other words, the computer can re-route a certain portion of the content identified as including restricted data to the AR glasses, and the computer may maintain the rest of the content on the display screen. The use of the image data depicting the user may help prevent restricted data from being inadvertently displayed, such as if the user forgets to manually select the data to display on the AR glasses, thereby maintaining the restricted status of the data. These techniques may be especially helpful in the context of a vehicle, such as an automobile, train, bus, etc. In these contexts, occupants may be crowded close together, potentially giving another occupant a view of the user's display screen. For example, the computer may be an on-board computer of the vehicle, and an on-board camera may provide the image data depicting the user.

A computer includes a processor and a memory, and the memory stores instructions executable by the processor to determine that a user of a display screen is wearing augmented-reality glasses based on image data depicting the user and, in response to determining that the user is wearing the augmented-reality glasses and in response to identifying a portion of content for display by the display screen as including restricted data, display the portion with the augmented-reality glasses and omit the portion from displaying on the display screen. The display screen is separate from the augmented-reality glasses.

In an example, the instructions may further include instructions to identify the user based on the image data and, in response to determining that the user is wearing the augmented-reality glasses and identifying the user as a prestored user, display the portion with the augmented-reality glasses and prevent the portion from displaying on the display screen.

In an example, the instructions may further include instructions to receive the image data from a camera. In a further example, a vehicle occupied by the user may include the camera.

In another further example, a personal device being used by the user may include the camera and the display screen.

In an example, a personal device being used by the user may include the display screen. In a further example, the instructions may further include instructions to pair with the personal device and with the augmented-reality glasses.

In an example, the instructions may further include instructions to, in response to identifying a second portion of the content as not including restricted data, display the second portion on the display screen.

In an example, the instructions may further include instructions to, in response to determining that the user is not wearing the augmented-reality glasses, output a message prompting the user to put on the augmented-reality glasses.

In an example, the instructions may further include instructions to, in response to determining that the user removed the augmented-reality glasses, lock the display screen.

In an example, the instructions may further include instructions to, in response to an input from the user, display a second portion of the content with the augmented-reality glasses and prevent the second portion from displaying on the display screen.

In an example, the instructions may further include instructions to identify the portion of the content as including restricted data based on the portion including personally identifiable information of the user.

In an example, the instructions further include instructions to identify the portion of the content as including restricted data based on a data encryption tag associated with the portion.

In an example, the instructions may further include instructions to identify the portion of the content as including restricted data based on the portion including age-restricted material.

A method includes determining that a user of a display screen is wearing augmented-reality glasses based on image data depicting the user and, in response to determining that the user is wearing the augmented-reality glasses and in response to identifying a portion of content for display by the display screen as including restricted data, displaying the portion with the augmented-reality glasses and omit the portion from displaying on the display screen. The display screen is separate from the augmented-reality glasses.

In an example, the method may further include identifying the user based on the image data and, in response to determining that the user is wearing the augmented-reality glasses and identifying the user as a prestored user, displaying the portion with the augmented-reality glasses and prevent the portion from displaying on the display screen.

In an example, the method may further include receiving the image data from a camera. In a further example, a vehicle occupied by the user may include the camera.

In another further example, a personal device being used by the user may include the camera and the display screen.

In an example, the method may further include, in response to identifying a second portion of the content as not including restricted data, displaying the second portion on the display screen.

With reference to the Figures, wherein like numerals indicate like parts throughout the several views, a computer 105 includes a processor and a memory, and the memory stores instructions executable by the processor to determine that a user of a display screen 110 is wearing augmented-reality (AR) glasses 115 based on image data depicting the user and, in response to determining that the user is wearing the AR glasses 115 and in response to identifying a portion of content 200 for display by the display screen 110 as including restricted data, display the portion with the AR glasses 115 and prevent the portion from displaying on the display screen 110. The display screen 110 is separate from the AR glasses 115.

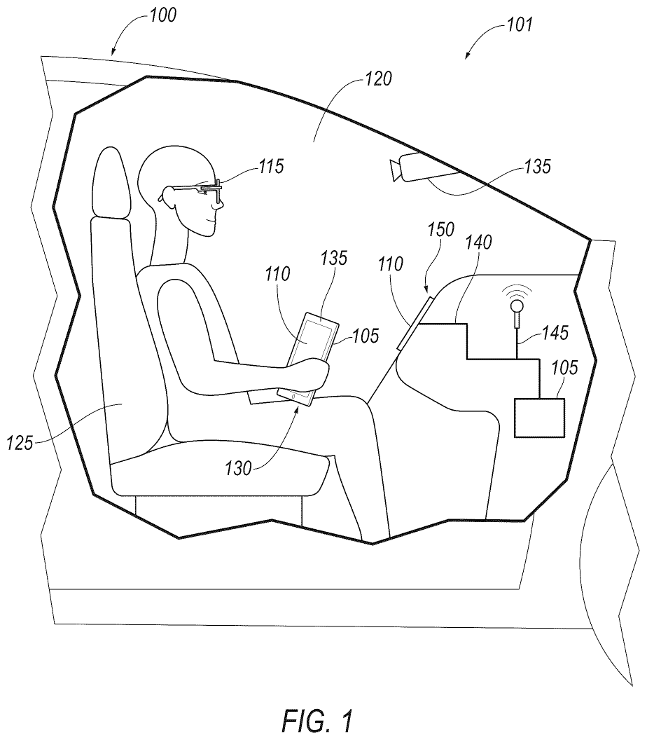

With reference to FIG. 1, an AR system 101 may include the computer 105, the display screen 110, and the AR glasses 115.

The AR system 101 described herein may be implemented in a vehicle 100. The vehicle 100 may be any passenger or commercial automobile such as a car, a truck, a sport utility vehicle, a crossover, a van, a minivan, a taxi, a bus, etc. Alternatively, the vehicle 100 may be another mode of transportation such as a train, subway, boat, airplane, etc.

The vehicle 100 includes a passenger compartment 120 to house occupants of the vehicle 100. For an automobile, the passenger compartment 120 may include one or more seats 125 disposed in a front row of the passenger compartment 120, one or more of the seats 125 disposed in a second row behind the front row, and/or one or more of the seats 125 in a third row at a rear of the passenger compartment 120. The position and orientation of the seats 125 and components thereof may be adjustable by an occupant. The user may occupy the vehicle 100 by being in the passenger compartment 120 and/or sitting in one of the seats 125.

The user may have a personal device 130 in the vehicle 100. The personal device 130 is a portable computing device such as a mobile phone (e.g., a smartphone), a laptop, or a tablet. The personal device 130 is distinct from the vehicle 100 and is not a component of the vehicle 100. The personal device 130 is a computing device including a processor and a memory. The personal device 130 is used and carried by the user, who may be the operator of the vehicle 100.

The display screen 110 is separate from the AR glasses 115. The display screen 110 may be a component of the personal device 130 or a component of the vehicle 100. In other words, the personal device 130 may include the display screen 110, or the vehicle 100 may include the display screen 110. For example, the display screen 110 may be a screen of a mobile phone, laptop, or tablet. Alternatively, the display screen 110 may be fixedly mounted within the passenger compartment 120 of the vehicle 100 (e.g., on a center stack or dashboard of the vehicle 100). The display screen 110 can be any suitable type for displaying content 200 legible to the user, such as light-emitting diode (LED), organic light-emitting diode (OLED), liquid crystal display (LCD), plasma, digital light processing technology (DLPT), etc.

The user may have the AR glasses 115 in the vehicle 100. The AR glasses 115 are wearable on a face of the user and extend in front of the eyes of the user. The AR glasses 115 provide the user with augmented reality, which combines the real world and computer-generated content superimposed on the real world from the point of view of the user. The AR glasses 115 have transparent lenses that permit the user to see their surroundings. The lenses of the AR glasses 115 also display content, which the user sees at the same time as viewing the world through the lenses. The AR glasses 115 may display content at a size and location on the lenses so that the content appears to the user to be at a specific location in the world. For example, the AR glasses 115 may use pose tracking to determine the position and orientation of the user's head with respect to the surroundings (e.g., based on data from inertial measurement units (IMUs) or the like).

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may be a component of the vehicle 100 or a component of the personal device 130. In other words, the vehicle 100 may include the computer 105, or the personal device 130 may include the computer 105. For example, the computer 105 may be an on-board computer of the vehicle 100 and mounted fixedly inside the vehicle 100. Alternatively, the computer 105 may be the processor and memory operating the personal device 130.

The AR system 101 may include a camera 135. The camera 135 can detect electromagnetic radiation in some range of wavelengths. For example, the camera 135 may detect visible light, infrared radiation, ultraviolet light, or some range of wavelengths including visible, infrared, and/or ultraviolet light. For example, the camera 135 can be a charge-coupled device (CCD), complementary metal oxide semiconductor (CMOS), or any other suitable type.

The camera 135 may be a component of the vehicle 100 or a component of the personal device 130. In other words, the vehicle 100 may include the camera 135, or the personal device 130 may include the camera 135. For example, the camera 135 may be fixedly mounted within the passenger compartment 120 of the vehicle 100 (e.g., at a front of the passenger compartment 120 and oriented rearwardly, as shown in FIG. 1). Alternatively, the camera 135 may be mounted to the personal device 130. In that case, the camera 135 may be oriented to face a same direction as the display screen 110 of the personal device 130 (i.e., toward a face of the user when the user is reading the display screen 110 of the personal device 130).

The computer 105 is programmed to receive the image data from the camera 135. The image data are a sequence of image frames of the field of view of the camera 135. Each image frame is a two-dimensional matrix of pixels. Each pixel has a brightness or color represented as one or more numerical values, such as a scalar unitless value of photometric light intensity between 0 (black) and 1 (white), or values for each of red, green, and blue (e.g., each on an 8-bit scale (0 to 255) or a 12- or 16-bit scale). The pixels may be a mix of representations (e.g., a repeating pattern of scalar values of intensity for three pixels and a fourth pixel with three numerical color values, or some other pattern). Position in an image frame (i.e., position in the field of view of the camera 135 at the time that the image frame was recorded) can be specified in pixel dimensions or coordinates (e.g., an ordered pair of pixel distances), such as a number of pixels from a top edge and a number of pixels from a left edge of the image frame.

The vehicle 100 may include a communications network 140. As a component of the vehicle 100, the computer 105 may transmit and receive data through the communications network 140. The communications network 140 may be a controller area network (CAN) bus, Ethernet, Wi-Fi, Local Interconnect Network (LIN), onboard diagnostics connector (OBD-II), and/or any other wired or wireless communications network. The computer 105 may be communicatively coupled to the camera 135 (if part of the vehicle 100), the display screen 110 (if part of the vehicle 100), a transceiver 145, a user interface 150, and other components via the communications network 140.

The vehicle 100 may include the transceiver 145. The transceiver 145 may be adapted to transmit signals wirelessly through any suitable wireless communication protocol, such as cellular, Bluetooth®, Bluetooth® Low Energy (BLE), ultra-wideband (UWB), Wi-Fi, IEEE 802.11a/b/g/p, cellular-V2X (CV2X), Dedicated Short-Range Communications (DSRC), other RF (radio frequency) communications, etc. The transceiver 145 may be adapted to communicate with a remote server, that is, a server distinct and spaced from the vehicle 100. For example, the remote server may be associated with another vehicle (e.g., V2V communications), an infrastructure component (e.g., V2I communications), a first responder, the personal device 130 of the user, the AR glasses 115, etc. The transceiver 145 may be one device or may include a separate transmitter and receiver.

The vehicle 100 may include the user interface 150. The user interface 150 presents information to and receives information from an occupant of the vehicle 100. The user interface 150 may be located on an instrument panel in the passenger compartment 120 of the vehicle 100, and/or wherever the user interface 150 may be readily seen by the occupant. The user interface 150 may include dials, digital readouts, screens, speakers, and so on for providing information to the occupant, such as human-machine interface (HMI) elements such as are known. For example, the user interface 150 may include the display screen 110 of the vehicle 100. The user interface 150 may include buttons, knobs, keypads, microphone(s), and so on for receiving information from the occupant.

The computer 105 may be programmed to receive user inputs from the user via the user interface 150 and/or the personal device 130. For example, the user may use buttons or keys, touchscreen, trackpad, etc. of the personal device 130 or user interface 150. For another example, the user may provide a voice command audible to a microphone of the personal device 130 or user interface 150, and the computer 105 may interpret the voice command using known algorithms. For another example, the user may provide a gesture command. The computer 105 may receive the image data from the camera 135 depicting the user performing the gesture command, and the computer 105 may interpret the gesture command using known algorithms. The image data may be from the same camera 135 as the camera 135 that generated the image data used to determine whether the user is wearing the AR glasses 115 (as described below).

The computer 105 may be programmed to pair with the personal device 130 and/or with the AR glasses 115. For the purposes of this disclosure, “pairing” is defined as establishing a connection permitting communication between two devices. The computer 105 may establish the connection using the transceiver 145. The connection may include negotiations between the transceiver 145 and the personal device 130 or AR glasses 115. Each negotiation identifies the transceiver 145 to the personal device 130 or AR glasses 115 and then identifies the personal device 130 or AR glasses 115 to the transceiver 145, permitting signals to be transmitted between the transceiver 145 and the personal device 130 or AR glasses 115. The connection may use any suitable protocol (e.g., Bluetooth®). The connection may be encrypted or not encrypted.

The computer 105 may be programmed to identify the user (i.e., determine that the user is a prestored user, in other words, a known, specific user having an identity stored in the memory of the computer 105). The computer 105 may identify the user based on the image data. The computer 105 can perform facial recognition on the image data to determine whether the face depicted in the image data is a recognized face (i.e., a face stored in memory of a known individual such as an operator of the vehicle 100). The computer 105 can use any suitable facial-recognition technique, such as template matching; statistical techniques such as principal component analysis (PCA), discrete cosine transform, linear discriminant analysis, locality preserving projections, Gabor wavelet, independent component analysis, or kernel PCA; neural networks such as neural networks with Gabor filters, neural networks with Markov models, or fuzzy neural networks; etc.

Alternatively, the computer 105 may identify the user based on another input. For example, a sensor of the AR glasses 115 or the personal device 130 may provide a biometric authentication of the user (e.g., an iris scanner built into the AR glasses 115). For another example, the user can use a keyfob or the like to start the vehicle 100, and the keyfob can have an RFID tag or the like uniquely specifying the user from among other potential operators who regularly use the vehicle 100. The RFID signal can be associated with the user in memory. For another example, the computer 105 may identify the user based on the pairing of the personal device 130 or the AR glasses 115 with the computer 105. The personal device 130 or AR glasses 115 can be associated with the user in memory. For another example, the operator can enter identifying information such as a username and password or a passkey into the user interface 150.

The computer 105 may be programmed to, in response to identifying the user as not being a prestored user (i.e., in response to not recognizing the user), prompt the user to create a profile. The user may specify a restricted-data policy (described below) as part of the profile. The profile may be stored in memory. Once the profile is created, the computer 105 may identify the user as a prestored user the next time that the user attempts to use the vehicle 100.

The computer 105 is programmed to determine whether the user of the display screen 110 is wearing the AR glasses 115 based on the image data depicting the user. The computer 105 may detect the face of the user and then classify the face as wearing the AR glasses 115 or not wearing the AR glasses 115. The computer 105 may rely on the facial-recognition algorithm already performed for detecting the face or may use a facial-detection technique, such as knowledge-based techniques such as a multiresolution rule-based method; feature-invariant techniques such as grouping of edges, space gray-level dependence matrix, or mixture of Gaussian; template-matching techniques such as shape template or active shape model; or appearance-based techniques such as eigenface decomposition and clustering, Gaussian distribution and multilayer perceptron, neural network, support vector machine with polynomial kernel, a naive Bayes classifier with joint statistics of local appearance and position, higher order statistics with hidden Markov model, or Kullback relative information.

Upon detecting the face, the computer 105 may classify the face as wearing the AR glasses 115 or not wearing the AR glasses 115. The computer 105 may employ conventional image-recognition techniques, for example, a convolutional neural network programmed to accept images depicting faces as input and output a classification of the face. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential classification (in this case, wearing AR glasses 115 or not wearing AR glasses 115), and the final output is the classification with the highest score.

The computer 105 may be programmed to, in response to determining that the user is not wearing the AR glasses 115, output a message prompting the user to put on the AR glasses 115. For example, the computer 105 may output the message via the user interface 150 (e.g., via the display screen 110). The message may ask the user whether the user wants to put on the AR glasses 115. Outputting the message may also be conditional on identifying the user as a prestored user. In other words, the computer 105 may be programmed to, in response to determining that the user is not wearing the AR glasses 115 and identifying the user as a prestored user (e.g., as a prestored user that possesses AR glasses 115), output the message. A profile of the user stored in the memory may indicate that the user possesses AR glasses 115.

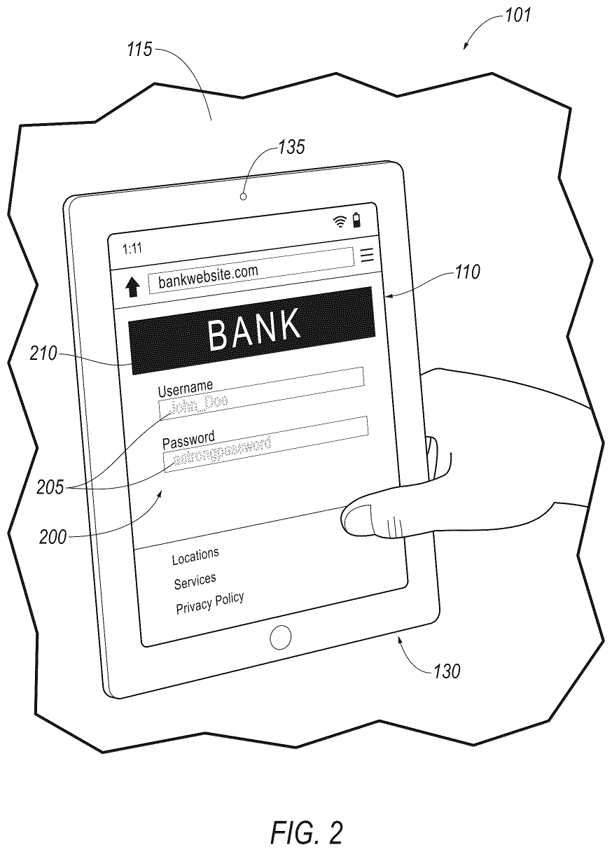

The computer 105 may be programmed to, in response to determining that the user is wearing the AR glasses 115, display a portion of content 200 including restricted data with the AR glasses 115 and prevent the portion from displaying on the display screen 110, as will be described below with respect to FIG. 2. For example, the computer 105 may apply a restricted-data policy. Applying the restricted-data policy may also be conditional on identifying the user as a prestored user. In other words, the computer 105 may be programmed to, in response to determining that the user is wearing the AR glasses 115 and identifying the user as a prestored user, apply the restricted-data policy. The profile of the user stored in the memory may specify the restricted-data policy.

With reference to FIG. 2, content 200 may be set for display on the display screen 110. For example, the user may request the content 200 by, for example, navigating to a website, selecting media to play, opening an app, etc. on the display screen 110 of the personal device 130 or the computer 105. Instead of displaying the content 200 in full on the display screen 110, the computer 105 may divide the display of the content 200 between the display screen 110 and the AR glasses 115 in response to conditions described below. The computer 105 may identify a first portion 205 of the content 200 for display by the AR glasses 115 and a second portion 210 of the content 200 (e.g., the remainder of the content 200) for display by the display screen 110, as will be described below. In the example shown in FIG. 2, the first portion 205 is a username and password entered on a website, and the second portion 210 is the remainder of the website and the other content on the display screen 110. The computer 105 displays the first portion 205 with the AR glasses 115 and prevents the first portion 205 from displaying on the display screen 110, while displaying the second portion 210 on the display screen 110. For example, the area of the content 200 on the display screen 110 that would be occupied by the first portion 205 may instead be blank (e.g., white or a preset background color). The AR glasses 115 may display the first portion 205 at a location on the lenses, orientation, and size that correspond to the position that the first portion 205 would occupy if displayed on the display screen 110. In the example of FIG. 2, the fields of the website for entry of the username and password are blank on the display screen 110, and the username and password are displayed by the AR glasses 115 so as to be positioned in the fields as seen by the user wearing the AR glasses 115.

The computer 105 may be programmed to identify a portion of the content 200 as including restricted data. The computer 105 may identify the portion based on metadata associated with the content 200 that labels the portion with a specific label that is prestored in the memory.

For example, the computer 105 may identify a portion of the content 200 as including restricted data based on the portion including personally identifiable information of the user. For the purposes of this disclosure, “personally identifiable information” is defined as a representation of information that permits the identity of an individual to whom the information applies to be reasonably inferred. Examples of personally identifiable information include usernames; passwords; identifying numbers such as social security numbers, drivers license or passport numbers, or account numbers; addresses; phone numbers; email addresses; biometric data; etc.

For another example, the computer 105 may identify the portion of the content 200 as including restricted data based on a data encryption tag associated with the portion. The data encryption tag indicates that certain data being transmitted to the computer 105 or personal device 130 is encrypted (e.g., a certificate for HTTPS (HyperText Transfer Protocol Secure)). Examples include secure websites, messages transmitted over an encrypted messaging application, etc.

For another example, the computer 105 may identify the portion of the content 200 as including restricted data based on the portion including age-restricted material. Certain media such as movies or games may include a rating recommending a minimum age for accessing the media (e.g., issued by the Motion Picture Association of America (MPAA) or Entertainment Software Rating Board (ESRB)), which may be stored as metadata associated with the media.

The computer 105 may store the restricted-data policy. The restricted-data policy specifies how to treat restricted data, including whether to display the restricted data with the AR glasses 115 instead of with the display screen 110. The restricted-data policy may include rules for different types of restricted data. The rules may define, for the respective types of restricted data, whether to display the portion including the restricted data with the AR glasses 115 or the display screen 110 (e.g., displaying personally identifiable information and movies rated “R” on the AR glasses 115 and other content on the display screen 110). The restricted-data policy may be specific to the user and associated with the user in the profile for the user stored in the memory of the computer 105. The user may provide user inputs modifying the restricted-data policy for that user.

The computer 105 is programmed to, in response to identifying a portion of the content 200 as including restricted data covered by the restricted-data policy, apply the restricted-data policy to the content 200. The restricted-data policy includes the rules specifying the restricted data for display by the AR glasses 115 instead of the display screen 110. Applying the restricted-data policy includes, for portions of the content 200 covered by the rules, displaying those portions with the AR glasses 115 and preventing those portions from displaying on the display screen 110, as described above for the first portion 205. Applying the restricted-data policy further includes, for portions of the content 200 not covered by the rules, displaying those portions on the display screen 110, as described above for the second portion 210 (unless moved to the AR glasses 115 as described below).

The computer 105 may be programmed to, in response to an input from the user, display a portion of the content 200 with the AR glasses 115 and prevent the portion from displaying on the display screen 110 (as described above). The user may provide the user input in any manner described above (e.g., touchscreen, gesture, etc.). The input may indicate which portion of the content 200 is to be displayed on the AR glasses 115 (e.g., encircling the portion on the touchscreen or with a gesture). The computer 105 may have determined that the portion lacked restricted content. The user can thus select additional portions of content 200 to display on the AR glasses 115 in addition to the portion having restricted data. Similarly, the computer 105 may be programmed to, in response to an input from the user, display a portion of the content 200 with the display screen 110 that was previously displayed on the AR glasses 115.

The computer 105 may be programmed to track a length of time that the user is using the AR glasses 115. For example, the computer 105 may store a time at which the AR glasses 115 are paired with the computer 105 and periodically subtract the stored time from a current time, or the computer 105 may start a timer when the AR glasses 115 are paired with the computer 105. The computer 105 may output a message to the user (e.g., via the user interface 150) in response to the length of time exceeding a time threshold. The message may indicate that the user has been using the AR glasses 115 for an extended period of time. The time threshold may be chosen to be less than a length of time at which motion sickness from using the AR glasses 115 may sometimes occur.

The computer 105 may be programmed to, in response to determining that the user removed the AR glasses 115, cease displaying portions of the content 200 on the AR glasses 115, display those portions on the display screen 110, and lock the display screen 110. Locking the display screen 110 means displaying something that covers the content 200 on the display screen 110 or deactivating the display screen 110. The computer 105 may only unlock the display screen 110 in response to an input from the user verifying the identity of the user. Locking the display screen 110 may block the portions of the content 200 containing restricted data from being displayed on the display screen 110, while still giving the user the option to unlock the display screen 110 if the user wants to continue interacting with the content 200.

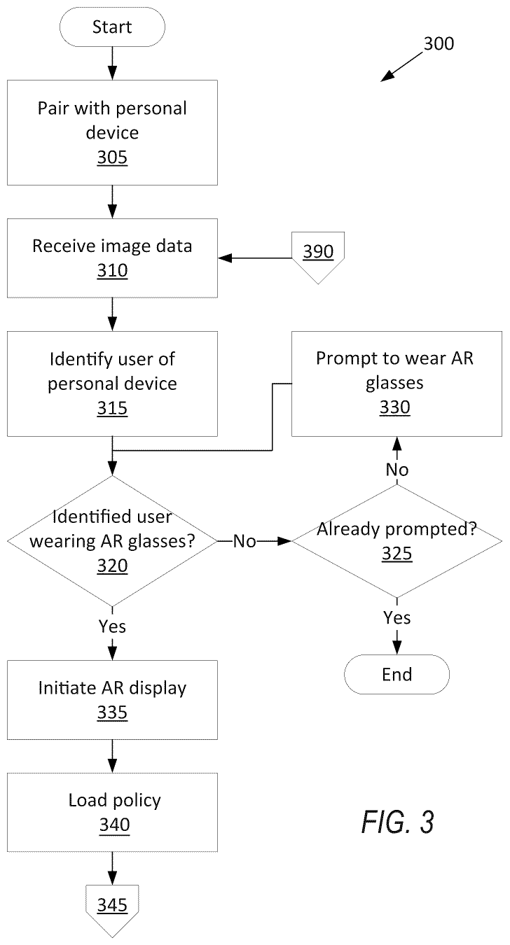

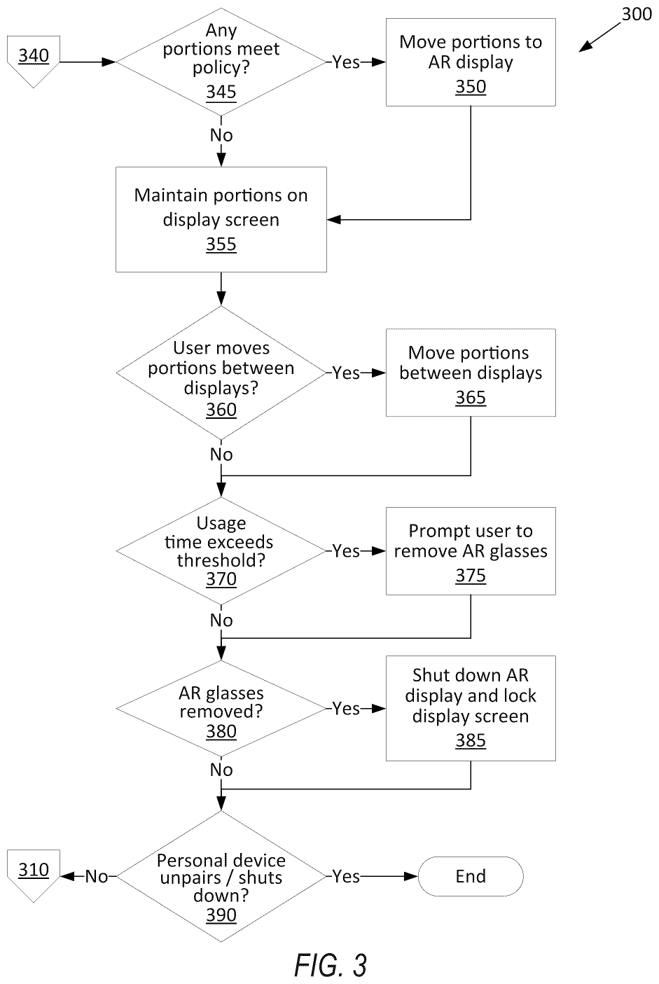

FIG. 3 is a flowchart illustrating an example process 300 for controlling the display screen 110 and AR glasses 115. The memory of the computer 105 stores executable instructions for performing the steps of the process 300 and/or programming can be implemented in structures such as mentioned above. As a general overview of the process 300, the computer 105 pairs with the personal device 130 and AR glasses 115, receives the image data from the camera 135, and identifies the user of the personal device 130. The computer 105, in response to either not recognizing the user or determining that the user is not wearing the AR glasses 115, prompts the user to create a profile or put on the AR glasses 115 (unless already prompted) and checks again. The computer 105, in response to identifying the user as a prestored user and determining that the user is wearing the AR glasses 115, initiates the AR glasses 115 and loads the restricted-data policy of the user. In response to identifying a portion of the content 200 as including restricted data, the computer 105 displays the portion with the AR glasses 115 and prevents the portion from the display screen 110, and the computer 105 displays the remaining portion on the display screen 110. In response to an input from the user, the computer 105 displays a portion of the content 200 on the AR glasses 115 and prevents the portion from the display screen 110 (or vice versa). In response to the usage time of the AR glasses 115 exceeding a threshold, the computer 105 outputs a message to the user. In response to determining that the user removed the AR glasses 115, the computer 105 ceases displaying portions of the content 200 on the AR glasses 115, displays those portions on the display screen 110, and locks the display screen 110. The process 300 continues until the user unpairs or shuts down the personal device 130.

The process 300 begins in a block 305, in which the computer 105 pairs with the personal device 130 and with the AR glasses 115, as described above.

Next, in a block 310, the computer 105 receives the image data from the camera 135, as described above.

Next, in a block 315, the computer 105 identifies the user (e.g., based on the image data), as described above.

Next, in a decision block 320, the computer 105 determines whether the user is wearing the AR glasses 115 based on the image data depicting the user from the block 310 and determines whether the user is a prestored user. In response to either not recognizing the user or determining that the user is not wearing the AR glasses 115, the process 300 proceeds to a decision block 325. In response to identifying the user as a prestored user and determining that the user is wearing the AR glasses 115, the process 300 proceeds to a block 335.

In the decision block 325, the computer 105 determines whether the computer 105 already provided the prompt in a block 330 to the user at least once. If the computer 105 has not provided the prompt, the process 300 proceeds to the block 330. If the computer 105 has provided the prompt, the process 300 ends.

In the block 330, the computer 105 outputs a message prompting the user to put on the AR glasses 115 (if the computer 105 identified the user as a prestored user in the block 315) or outputs a message prompting the user to create a profile (if the computer 105 did not recognize the user in the block 315). After the block 330, the process 300 returns to the decision block 320.

In the block 335, the computer 105 initiates an AR display by the AR glasses 115, in other words, sets the AR glasses 115 as a possible destination for outputting portions of content 200.

Next, in a block 340, the computer 105 loads the restricted-data policy from the profile for the user identified in the block 315. The computer 105 makes that restricted-data policy an active policy that is currently governing the display of content 200.

Next, in a decision block 345, the computer 105 identifies whether any portions of the content 200 include restricted data, as described above. In response to identifying a portion of the content 200 as including restricted data, the process 300 proceeds to a block 350. In response to identifying the content 200 as not including restricted data, the process 300 proceeds to a block 355.

In the block 350, the computer 105 displays the first portion 205 with the AR glasses 115 and prevents the first portion 205 from displaying on the display screen 110, as described above. After the block 350, the process 300 proceeds to the block 355.

In the block 355, the computer 105 displays the second portion 210 (e.g., the remaining portion of the content 200) on the display screen 110, as described above. If the computer 105 did not identify restricted data in the content 200 in the decision block 345, the second portion 210 is the entirety of the content 200.

Next, in a decision block 360, the computer 105 determines whether the computer 105 has received an input from the user to move a portion of the content 200 between the display screen 110 and the AR glasses 115, as described above. In response to an input from the user, the process 300 proceeds to a block 365. In the absence of an input, the process 300 proceeds to a decision block 370.

In the block 365, the computer 105 displays the portion of the content 200 indicated with the input with the AR glasses 115 and prevents the portion from displaying on the display screen 110, or displays the portion on the display screen 110 instead of the AR glasses 115, as indicated by the input, as described above. After the block 365, the process 300 proceeds to the decision block 370.

In the decision block 370, the computer 105 determines whether the length of time that the user has been using the AR glasses 115 exceeds a threshold, as described above. In response to the length of time exceeding the threshold, the process 300 proceeds to a block 375. In response to the length of time being below the threshold, the process 300 proceeds to a decision block 380.

In the block 375, the computer 105 prompts the user to remove the AR glasses 115, as described above. After the block 375, the process 300 proceeds to the decision block 380.

In the decision block 380, the computer 105 determines whether the user removed the AR glasses 115, as described above. In response to determining that the user removed the AR glasses 115, the process 300 proceeds to a block 385. In response to determining that the user is still wearing the AR glasses 115, the process 300 proceeds to a decision block 390.

In the block 385, the computer 105 ceases displaying the first portion 205 of the content 200 on the AR glasses 115, displays the first portion 205 on the display screen 110, and locks the display screen 110, as described above. After the block 385, the process 300 proceeds to the decision block 390.

In the decision block 390, the computer 105 determines whether the personal device 130 is no longer paired with the computer 105 or has been shut down. In response to the personal device 130 still being connected to the computer 105, the process 300 returns to the block 310. In response to the personal device 130 no longer being paired with the computer 105 or shutting down, the process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to,” “upon determining,” “upon detecting,” etc. indicates a causal relationship, not merely a temporal relationship. Many modifications and variations of the present disclosure are possible in light of the above teachings, and the disclosure may be practiced otherwise than as specifically described.

1. A computer comprising a processor and a memory, the memory storing instructions executable by the processor to:
identify a user of a display screen based on image data depicting the user;
determine that the user of the display screen is not wearing augmented-reality glasses based on the image data depicting the user, the display screen being separate from the augmented-reality glasses;
in response to determining that the user is not wearing the augmented reality glasses and in response to identifying the user as a prestored user with a profile indicating that the user possesses the augmented-reality glasses, output a message prompting the user to put on the augmented-reality glasses;
determine that the user is wearing the augmented-reality glasses based on the image data; and
in response to determining that the user is wearing the augmented-reality glasses and in response to identifying a portion of content for display by the display screen as including restricted data, display the portion with the augmented-reality glasses and prevent the portion from displaying on the display screen.

2. The computer of claim 1, wherein the instructions further include instructions to:
in response to determining that the user is wearing the augmented-reality glasses and identifying the user as the prestored user, display the portion with the augmented-reality glasses and prevent the portion from displaying on the display screen.

3. The computer of claim 1, wherein the instructions further include instructions to receive the image data from a camera.

4. The computer of claim 3, wherein a vehicle occupied by the user includes the camera.

5. The computer of claim 3, wherein a personal device being used by the user includes the camera and the display screen.

6. The computer of claim 1, wherein a personal device being used by the user includes the display screen.

7. The computer of claim 6, wherein the instructions further include instructions to pair with the personal device and with the augmented-reality glasses.

8. The computer of claim 1, wherein the instructions further include instructions to, in response to identifying a second portion of the content as not including restricted data, display the second portion on the display screen.

9. (canceled)

10. The computer of claim 1, wherein the instructions further include instructions to, in response to determining that the user removed the augmented-reality glasses, lock the display screen.

11. The computer of claim 1, wherein the instructions further include instructions to, in response to an input from the user, display a second portion of the content with the augmented-reality glasses and prevent the second portion from displaying on the display screen.

12. The computer of claim 1, wherein the instructions further include instructions to identify the portion of the content as including restricted data based on the portion including personally identifiable information of the user.

13. The computer of claim 1, wherein the instructions further include instructions to identify the portion of the content as including restricted data based on a data encryption tag associated with the portion.

14. The computer of claim 1, wherein the instructions further include instructions to identify the portion of the content as including restricted data based on the portion including age-restricted material.

15. A method comprising:
identifying a user of a display screen based on image data depicting the user;
determining that the user of the display screen is not wearing augmented-reality glasses based on the image data depicting the user, the display screen being separate from the augmented-reality glasses;
in response to determining that the user is not wearing the augmented-reality glasses and in response to identifying the user as a prestored user with a profile indicating that the user possesses the augmented-reality glasses, outputting a message prompting the user to put on the augmented-reality glasses;
determining that the user is wearing the augmented-reality glasses based on the image data; and
in response to determining that the user is wearing the augmented-reality glasses and in response to identifying a portion of content for display by the display screen as including restricted data, displaying the portion with the augmented-reality glasses and omit the portion from displaying on the display screen.

16. The method of claim 15, further comprising:
in response to determining that the user is wearing the augmented-reality glasses and identifying the user as the prestored user, displaying the portion with the augmented-reality glasses and prevent the portion from displaying on the display screen.

17. The method of claim 15, further comprising receiving the image data from a camera.

18. The method of claim 17, wherein a vehicle occupied by the user includes the camera.

19. The method of claim 17, wherein a personal device being used by the user includes the camera and the display screen.

20. The method of claim 15, further comprising, in response to identifying a second portion of the content as not including restricted data, displaying the second portion on the display screen.

21. The computer of claim 1, wherein the instructions further include instructions to, in response to a length of time that the user is using the augmented-reality glasses exceeding a time threshold, output a second message to the user indicating that the user has been using the augmented-reality glasses for an extended period of time.
